(19) United States
(12) Patent Application Publication
(10) Pub. No.: US 2025/0136181 A1
(43) Pub. Date: May 1, 2025

(54) EVASIVE STEERING THREAT ZONE DETERMINATION AND CONTROL

(71) Applicant: GM GLOBAL TECHNOLOGY OPERATIONS LLC, Detroit, MI (US)

(72) Inventors: Harsh Ketan PATEL, New Hudson, MI (US); Jeffrey Scott Parks, Ann Arbor, MI (US); Namal P. Kumara, Ypsilanti, MI (US); Shaun C. Bowman, Ann Arbor, MI (US)

(21) Appl. No.: 18/498,166

(22) Filed: Oct. 31, 2023

(51) Int. Cl. B62D 15/02; G08G 1/16

(52) U.S. Cl. CPC B62D 15/0265; G08G 1/16

(57) ABSTRACT

A vehicle system includes an avoid evasive steering (AES) module configured to automatically control the vehicle, and a control module. The control module is configured to detect whether a first threat is present in front of the vehicle, in response to detecting the first threat in front of the vehicle, determine a path of the vehicle for an AES maneuver to avoid the first threat, generate a threat region of interest lateral to the vehicle along the path of the vehicle for the AES maneuver, determine whether a second threat is present in the threat region of interest, and in response to determining that the second threat is present in the threat region of interest, prevent the AES module from initiating control of the vehicle according to the AES maneuver. Other example vehicle systems and methods for evasive steering control in vehicles are also disclosed.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to evasive steering threat zone determination and control.

A vehicle often includes a driver assistance system. For example, the driver assistance system may include assisted evasive steering, blind spot detection, adaptive cruise control, lane departure warnings, etc. The assisted evasive steering is a driver-initiated collision avoidance steering mechanism. When the assisted evasive steering is employed and the driver begins to steer the vehicle around an object (e.g., another vehicle), the system applies additional steering torque to assist the vehicle around the object. In some cases, the system applies steering torque in the opposite direction after the vehicle passes the object.

### SUMMARY

A vehicle system for evasive steering control in a vehicle includes an avoid evasive steering (AES) module configured to automatically control the vehicle, and a control module in communication with the AES module. The control module is configured to detect whether a first threat is present in front of the vehicle, in response to detecting the first threat in front of the vehicle, determine a path of the vehicle for an AES maneuver to avoid the first threat in front of the vehicle, generate a threat region of interest lateral to the vehicle along the path of the vehicle for the AES maneuver, determine whether a second threat is present in the threat region of interest, and in response to determining that the second threat is present in the threat region of interest, prevent the AES module from initiating control of the vehicle according to the AES maneuver.

In other features, the control module is configured to transmit a control signal to the AES module to initiate control of the vehicle according to the AES maneuver in response to determining that the second threat is not present in the threat region of interest.

In other features, the threat region of interest is an irregular polygonal shape defined by a boundary corresponding to a geometry of a road in which the vehicle is moving on.

In other features, the control module is configured to construct vertices of the boundary based on one or more of a width of a road lane, a trajectory of the vehicle, an area associated with the first threat in front of the vehicle, and a width associated with the vehicle.

In other features, the control module is configured to identify, based on data received from one or more sensors, the second threat lateral to the vehicle as the vehicle is moving, and project a vector to determine whether the second threat is present in the threat region of interest.

In other features, the control module is configured to determine kinematic information associated with the second threat and track the second threat based on the kinematic information.

In other features, the control module is configured to track the second threat based on one or more previous values of the kinematic information.

In other features, the control module is configured to receive vehicle data associated with one or more parameters of the vehicle while the vehicle is moving, the vehicle data indicative of an intent of a driver controlling the vehicle, receive non-driver data indicative of environment parameters in front of the vehicle while the vehicle is moving, and detect whether the first threat is present in front of the vehicle based on the vehicle data and the non-driver data.

In other features, the one or more parameters of the vehicle includes at least one of a steering angle received from a steering angle sensor in the vehicle and a brake signal received from a braking sensor in the vehicle.

In other features, the non-driver data includes data associated with another vehicle in front of the vehicle.

In other features, the control module is configured to determine a confidence value of the driver based on the vehicle data, determine a threat value based on the non-driver data, calculate a score based on the confidence value and the threat value, and detect whether the first threat is present in front of the vehicle based on the score and a threshold.

In other features, a vehicle includes the vehicle system configured to control evasive steering of the vehicle.

A method for controlling evasive steering in a vehicle includes detecting whether a first threat is present in front of the vehicle, in response to detecting the first threat in front of the vehicle, determining a path of the vehicle for an AES maneuver to avoid the first threat in front of the vehicle, generating a threat region of interest lateral to the vehicle along the path of the vehicle for the AES maneuver, determining whether a second threat is present in the threat region of interest, and in response to determining that the second threat is present in the threat region of interest, preventing an AES module from initiating control of the vehicle according to the AES maneuver.

In other features, the threat region of interest is an irregular polygonal shape defined by a boundary corresponding to a geometry of a road in which the vehicle is moving on.

In other features, the method further includes constructing vertices of the boundary based on one or more of a width of a road lane, a trajectory of the vehicle, an area associated with the first threat in front of the vehicle, and a width associated with the vehicle.

In other features, determining whether the second threat is present in the threat region of interest includes identifying, based on data received from one or more sensors, the second threat lateral to the vehicle as the vehicle is moving, and projecting a vector to determine whether the second threat is present in the threat region of interest.

In other features, the method further includes determining kinematic information associated with the second threat and tracking the second threat based on the kinematic information.

In other features, tracking the second threat includes tracking the second threat based on one or more previous values of the kinematic information.

In other features, the method further includes receiving vehicle data associated with one or more parameters of the vehicle while the vehicle is moving, the vehicle data indicative of an intent of a driver controlling the vehicle, and receiving non-driver data indicative of environment parameters in front of the vehicle while the vehicle is moving.

In other features, detecting whether the first threat is present in front of the vehicle includes detecting whether the first threat is present in front of the vehicle based on the vehicle data and the non-driver data.

In other features, the method further includes determining a confidence value of the driver based on the vehicle data, determining a threat value based on the non-driver data, and calculating a score based on the confidence value and the threat value.

In other features, detecting whether the first threat is present in front of the vehicle includes detecting whether the first threat is present in front of the vehicle based on the score and a threshold.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example vehicle system for evasive steering control in a vehicle, according to the present disclosure;

FIG. 2 is a vehicle including portions of the vehicle system of FIG. 1, according to the present disclosure;

FIG. 3 is a diagram of the vehicle of FIG. 2, a front threat vehicle, and threat regions of interest to the left and right of the vehicles, according to the present disclosure;

FIG. 4 is a diagram of the vehicles and one of the threat regions of interest of FIG. 3, with identified targets inside and outside of the threat region of interest, according to the present disclosure;

FIG. 5 is a diagram of the threat region of interest of FIG. 4, with vectors projecting to identified targets inside and outside of the threat region of interest, according to the present disclosure;

FIG. 6 is a diagram including the vehicles and one of the threat regions of interest of FIG. 4, with a target path of an AES maneuver being prevented, according to the present disclosure; and

FIGS. 7-11 are flowcharts of example control processes for evasive steering control in a vehicle, according to the present disclosure.

In the drawings, reference numbers may be reused to identify similar and/or identical elements.

### DETAILED DESCRIPTION

A vehicle may implement assisted evasive steering or assisted evasive steer (AES) for assisting a driver to steer around an object, such as another vehicle on the road. In such examples, the AES is a driver-initiated collision avoidance steering mechanism that applies additional steering torque to assist the vehicle around the object. This helps the driver reach a maximum steering angle more quickly and therefore avoid a collision with the object. The AES is conventionally activated based on vehicle dynamics (e.g., changes in the forward movement of the vehicle in response to driver inputs) and detected primary threats in front of the vehicle. As such, the conventional AES activation does not take into account various other threats (e.g., side threats) around the vehicle. As a result, conventional AES may miss potential threats and/or encounter false positive activations, each of which may result in increased chances of vehicle accidents.

The vehicle systems and methods according to the present disclosure leverage a created threat zone adjacent to a vehicle that is shaped to fit the road geometry and a target path of the vehicle to determine whether threats are present in the threat zone, and then prevent or enable an AES maneuver for the vehicle based on whether threats are present in the threat zone. For example, and as further explained herein, the vehicle systems and methods trigger the AES maneuver to avoid a threat (e.g., a primary front threat) in front of the vehicle when another threat (e.g., a side threat) does not exist in the created threat zone. In doing so, the vehicle systems and methods provide robust and accurate assisted steering avoidance solutions while utilizing a low power computer hardware platform and low-cost sensors.

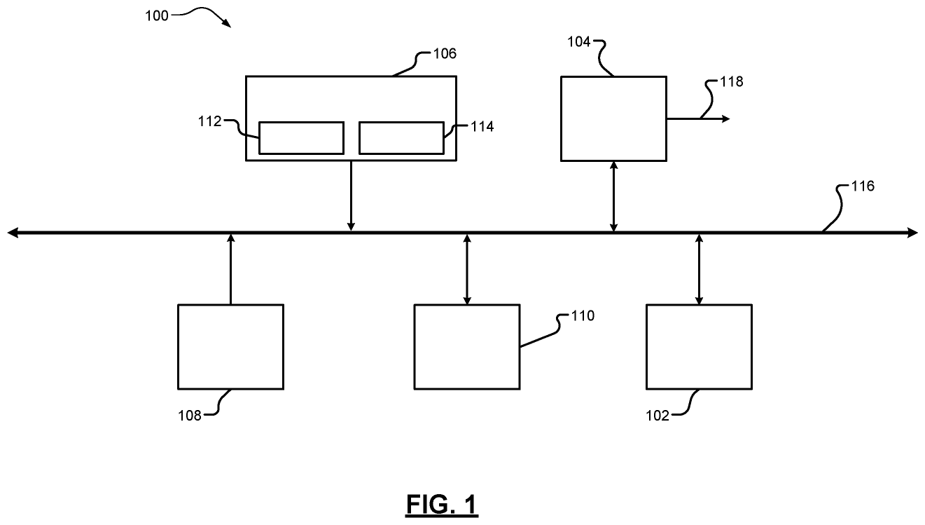

Referring now to FIG. 1, a block diagram of an example vehicle system 100 is presented for evasive steering control in a vehicle. As shown in FIG. 1, the vehicle system 100 generally includes a control module 102, an AES control module 104, a detection module 106, and various sensors. In the example of FIG. 1, the sensors may include a steering sensor 108 and a braking sensor 110 as shown. Additionally, the detection module 106 may include one or more sensors 112 and/or one or more cameras 114 as further explained below.

Although FIG. 1 illustrates the vehicle system 100 as including specific modules, it should be appreciated that one or more other modules may be employed if desired. Additionally, while the vehicle system 100 is shown as including multiple separate modules, any combination of the modules (e.g., the control module 102, the AES control module 104, etc.) and/or the functionality thereof may be integrated into one or more modules. Further, although the vehicle system 100 of FIG. 1 is shown as including particular sensors, it should be appreciated that the system 100 and/or other systems may include more or less sensors, sensors having different functionalities, etc.

In various embodiments, the modules and sensors of the vehicle system 100 may be in communication with each other and may share parameters via a network 116, such as a controller (or car) area network (CAN). In such examples, the parameters may be shared via one or more data buses of the network 116. As such, various parameters may be made available by a given module and/or sensor to other modules and/or sensors via the network 116.

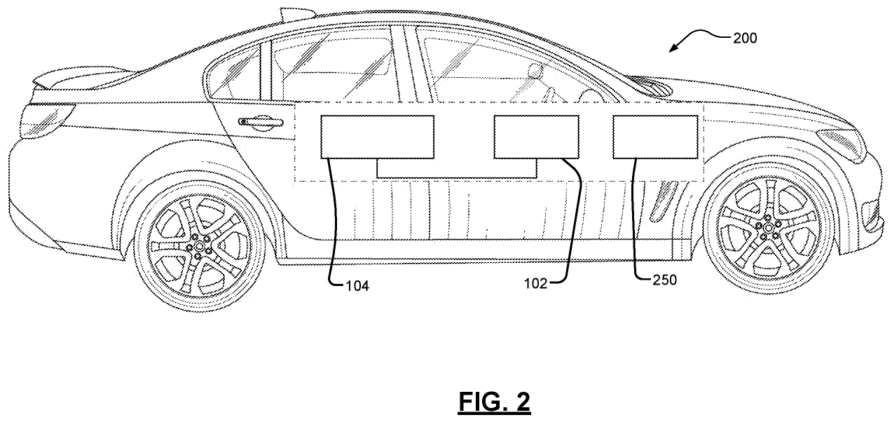

The system 100 of FIG. 1 may be employable in any suitable vehicle, such as an electric vehicle (e.g., a pure electric vehicle, a plug-in hybrid electric vehicle, etc.), an internal combustion engine vehicle, etc. Additionally, the system 100 may be applicable to an autonomous vehicle, a semi-autonomous vehicle, etc. For example, FIG. 2 depicts a vehicle (e.g., a host vehicle) 200 including the control module 102 and the AES control module 104 of FIG. 1, and one or more sensors 250 (e.g., the steering sensor 108, the braking sensor 110, sensors/cameras of the detection module 106, etc.) in communication with the control module 102 and/or the AES control module 104.

With continued reference to FIG. 1, the steering sensor 108 may generally monitor a torque associated with a steering wheel in the vehicle. For example, the steering sensor 108 may monitor or otherwise sense a torque applied by a driver to the steering wheel when the driver is steering (e.g., evasive steering) the vehicle in a left or right direction. The steering sensor 108 may then transmit a signal indicative of the torque to the control module 102 via the network 116. In other examples, the steering sensor 108 may monitor or otherwise sense a torque associated with a torque bar in the vehicle.

The braking sensor 110 may generally monitor a brake pedal position in the vehicle. For example, the braking sensor 110 may monitor or otherwise sense a change in the brake pedal position when the driver presses the brake pedal in the vehicle. The braking sensor 110 may then transmit a signal indicative of the brake pedal position, application of the brakes, etc. to the control module 102 via the network 116.

The detection module 106 may generally receive data relating to components in the vehicle and/or the environment external to the vehicle. For example, the detection module 106 may collect data indicative of detected objects, road conditions, weather conditions, braking, etc. for use in controlling various driver assistance systems (e.g., an AES system, etc.). In various embodiments, the detection module 106 may transmit data indicative of detected objects, road conditions, weather conditions, etc. to the AES control module 104 and/or the control module 102 via the network 116 for controlling vehicle steering, as further explained herein.

In various embodiments, the detection module 106 may include one or more detection devices. For example, the detection module 106 may include the sensor(s) 112 and/or the camera(s) 114 mounted on the exterior and/or interior of the vehicle. In such examples, the sensor(s) 112 may include any suitable type of sensor, such as radar sensors, lidar sensors, ultrasonic sensors, 3D sensors, etc. The sensors may be short-range sensors (e.g., short range radar (SRR) sensors, etc.) and/or long-range sensors (e.g., radar (LRR) sensors, etc.). In some examples, the camera(s) 114 may include a front view camera, a left view camera, and a right view camera (relative to the vehicle).

The AES control module 104 controls the vehicle to assist the driver in steering around an object, such as another vehicle on the road. In such examples, the AES control module 104 may analyze received data from the detection module 106, the steering sensor 108, the braking sensor 110, etc. and then, if applicable, provide a signal 118 for automatically controlling evasive steering in the vehicle. In various embodiments, the AES control module 104 may be prevented from providing the signal 118 and therefore controlling the vehicle based on actions from the control module 102, as further explained herein.

With continued reference to FIG. 1, the control module 102 initially detects whether a threat is present generally in front of the vehicle (e.g., the host vehicle). In such examples, the threat may be another vehicle traveling at a slower speed than the host vehicle, stopped in front of the moving host vehicle, etc. In various embodiments, the control module 102 detects the front threat based on received data, such as vehicle data and/or non-driver data.

For example, the control module 102 may receive non-driver data indicative of environment parameters in front of the host vehicle. In such examples, the non-driver data may include data associated with the other vehicle generally in front of the host vehicle. Such data may be provided by the detection module 106 (e.g., the sensor(s) 112 and/or the camera(s) 114).

Additionally, the control module 102 may receive vehicle data associated with one or more parameters of the host vehicle. In such examples, the vehicle data may be indicative of an intent of the driver controlling the host vehicle. For instance, the host vehicle parameters may include, for example, a steering angle received from the steering sensor 108 and/or a brake signal (e.g., representing the brake pedal position) received from the braking sensor 110. Then, based on the received vehicle data, the control module 102 determine an intent of the driver. For example, the control module 102 may determine the driver's intent of evasive steer to the left if the steering angle (e.g., a representative torque, etc.) indicates the driver is aggressively, quickly, etc. pulling the steering wheel to the left.

Then, the control module 102 may detect a presence of the front threat based on the vehicle data and non-driver data. For example, the control module 102 may determine a threat value associated with a front threat based on the non-driver data. In such examples, the threat value may take into account various parameters, such as attributes associated with the threat/target (e.g., a velocity, an acceleration, a lateral position, a longitudinal position, a heading, etc. of the threat/target), the type of threat/target, the diver's intent, etc. as further explained below. For instance, with respect to the attributes of the threat/target, the control module 102 may determine an estimated time to collision (TTC) between the host vehicle and the threat based on a relative longitudinal distance Lxᵣₑₗ between the host vehicle and the threat and a relative velocity of the threat Vxᵣₑₗ, as shown by equation (1) below. In such examples, the longitudinal distance Lxᵣₑₗ and the velocity Vxᵣₑₗ may be calculated or otherwise determined based data from the detection module 106.

$$TTC = \frac{{L}_{Xrel}}{- {V}_{Xrel}} \qquad Equation ( 1 )$$

The control module 102 may also determine or classify the threat type associated with the threat when determining the threat value. For example, the front threat may be classified as a stopped or stationary object threat type (e.g., never seen moving), a sudden braking threat type (e.g., the host vehicle is following the target/threat in adaptive cruise control and the target/threat brakes suddenly), a sudden braking with additional actors threat type (e.g., similar to the sudden braking threat type but with other vehicles ahead performing evasive steering maneuvers), and a cut-in target threat type (e.g., the target/threat is moving into an area in front of the host vehicle). While specific examples of threat types are described, it should be appreciated that more or less threat types and/or different threat types may be employed if desired. Regardless, each threat type may be associated with a value that may be used in determining the threat value.

Additionally, when detecting the presence of the front threat, the control module 102 may determine a confidence value associated with the driver based on the driver data. In such examples, the confidence value may be a generated value based on the intent of the driver (e.g., the amount of torque applied to the steering wheel, the torque rate, the amount of displacement of the brake pedal, etc.).

Then, the determined confidence value and threat value may be used to generally score the front target/threat. For example, equation (2) below provides one example relationship for generating a front threat score(S). In equation (2), K_{ttc}, Kᵥ, Kₜₜ, and K_{dc} represent the determined values for the time to collision (TTC), the host vehicle's velocity, the threat type, and the confidence value for the driver, respectively. Additionally, equation (2), K_{ttc} {TTC}, Kᵥ {Vxᵣₑₗ}, Kₜₜ {ThreatType}, and K_{dc} {DriverConf} represent look up values for the time to collision (TTC), the host vehicle's velocity, the threat type, and the confidence value for the driver, respectively.

$$S = \frac{{K}_{ttc} \{ TTC \} + {K}_{v} \{ {V}_{Xhost} \} + {K}_{tt} \{ ThreatType \} + {K}_{dc} \{ DriverConf \}}{{K}_{ttc} + {K}_{v} + {K}_{tt} + {K}_{dc}} \qquad Equation ( 2 )$$

The control module 102 may then detect whether the target/threat is an actual threat in front of the vehicle based on the front threat score(S) and a threshold. For example, the control module 102 may compare the front threat score(S) and a defined threshold. If the front threat score(S) is greater than or equal to the defined threshold, the control module 102 may determine the threat as being present in front of the vehicle. In various embodiments, the score(S) may fall within any suitable range, such as between 0 and 1. In such examples, the defined threshold may be any suitable value within the range, such as 0.5, 0.6, 0.7, etc.

Then, in response to detecting the threat in front of the host vehicle, the control module 102 can determine a path of the host vehicle for an AES maneuver to avoid the threat. In various embodiments, the determined path (e.g., a target path) for the AES maneuver may include a heading (left or right) of the host vehicle based on, for example, the driver's intent, the kinematics of the threat/target, etc.

In various embodiments, the control module 102 then generates a threat region of interest lateral to the host vehicle along the determined path of the host vehicle for the AES maneuver. For example, if the determined path is to the left of the front threat, the control module 102 can generate a threat region (e.g., a left threat region) along the left side of the host vehicle. Alternatively, if the determined path is to the right of the front threat, the control module 102 can generate a threat region (e.g., a right threat region) along the right side of the host vehicle.

The left and/or right threat regions may be any suitable shape. For example, the threat region of interest may be generated as an irregular polygonal shape. In such examples, the irregular polygonal shape may be generally defined by a boundary corresponding to a geometry of the road in which the host vehicle is moving on. Such road geometry data may be obtained by, for example, the detection module 106, a mapping application, etc.

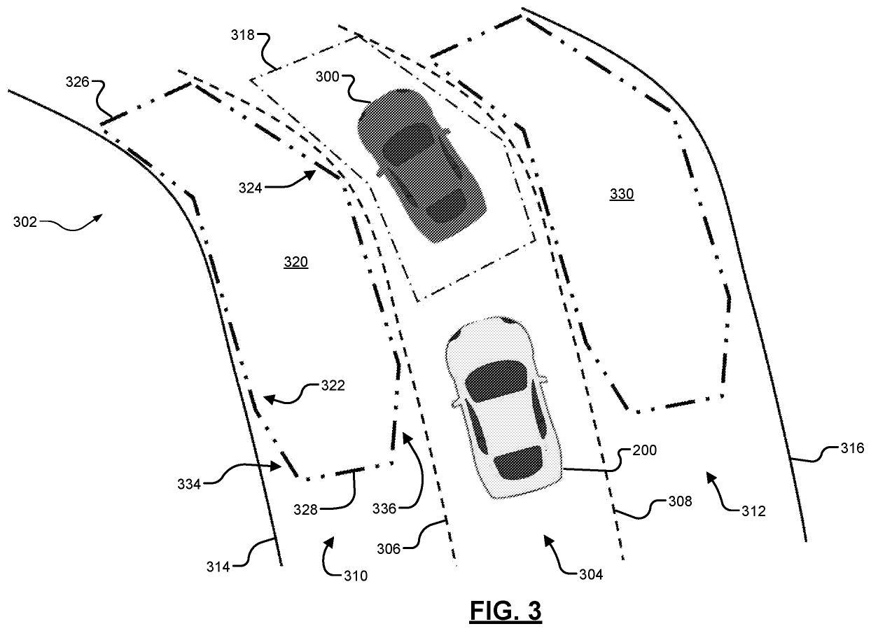

For example, FIG. 3 depicts a diagram including the host vehicle 200 of FIG. 2 and a front threat vehicle 300 traveling along a road 302. In the example of FIG. 3, the road 302 include a middle lane 304 defined by lane lines 306, 308, and opposing lanes 310, 312 on the left and right sides of the middle lane 304. The left lane 310 is defined by a lane line 314 and the lane line 306, and the right lane 312 is defined by a lane line 316 and the lane line 308.

In such examples, the host vehicle 200 includes the control module 102 of FIG. 1, which detects the vehicle 300 as being a threat (as explained above). Then, the control module 102 determines a path of the host vehicle 200 for an AES maneuver to avoid a threat region 318 associated with vehicle 300. If the target path is to the left, the control module 102 creates a threat region 320 of interest to the left of the host vehicle 200 and the vehicle 300 (e.g., along the target path of the host vehicle 200), as explained below. If, however, the target path is to the right, the control module 102 creates a threat region 330 of interest to the right of the host vehicle 200 and the vehicle 300 in a similar as the left threat region 320.

As shown in FIG. 3, the left threat region 320 is generally an irregular polygonal shape defined by a boundary corresponding to a geometry of the road 302 (e.g., the left lane 310). In the example of FIG. 3, the boundary of the left threat region 320 generally includes sides 322, 324, 326, 328 with lateral vertices (relative to the host vehicle 200), as shown in FIG. 3. In such examples, the control module 102 may construct the lateral vertices based on various parameters associated with the road, the host vehicle 300, the threat vehicle 200, etc. For example, the lateral vertices may be constructed based on one or more of a width of the road lane 310, a target trajectory of the host vehicle 200, an area (e.g., the threat region 318) associated with the threat vehicle 300, kinematics (e.g., position and velocity) of the threat vehicle 300, a width of the host vehicle 200, a calibratable zone of comfort, etc. Then, once the lateral vertices are constructed, the control module 102 may connect (or enclose) the lateral vertices to form the boundary of the left threat region 320.

Additionally, in some embodiments, the left and right threat regions 320, 330 may be constructed with one or more tapers as shown in FIG. 3. For example, the left threat region 320 is shown as including tapers 334, 336 at a rear portion of the region 320. Likewise, the right threat region 330 may include similar tapers (if applicable). In such examples, the tapers 334, 336 (e.g., exclusions of area from the region 320) may account for a lack of a rear object camera in the host vehicle 200. In some examples, the control module 102 of FIG. 1 may create the tapers 334, 336 when constructing the threat region 320 (or the threat region 330) by offsetting inwards the rearmost vertices of the threat region, thereby increasing feature availability.

In various embodiments, the control module 102 of FIG. 1 may create the threat region (e.g., a critical threat region) 318 around the vehicle 300 of FIG. 3. In such examples, the threat region 318 may be constructed in a similar manner as the left and right threat regions, as further explained below. For instance, the control module 102 may construct longitudinal vertices based on parameters associated with the road (e.g., a width of the lane 304, etc.), one or more of kinematics associated with the threat vehicle 300, etc. Then, once the longitudinal vertices are constructed, the control module 102 may connect (or enclose) the vertices to form the boundary of the threat region 318. In such examples, the control module 102 can exclude the front threat region 318 from the left threat region 320 or the right threat region 330, which in turn may reduce the number of false positive activations associated with detecting targets as side threats in the regions 320, 330 as further explained below.

With continued reference to FIG. 1, the control module 102 may determine whether another threat (e.g., a side threat) is present in the generated threat region of interest. For example, the control module 102 may identify one or more side threats that are generally lateral to the host vehicle 200 of FIG. 3 based on data obtained by, for example, the detection module 106. In various embodiments, the control module 102 may detect properties associated with the side threats, such as a type of threat (e.g., a car, a semitruck, etc. based on a size of the threat), the speed of the threat, etc.

In various embodiments, the control module 102 may transpose the target/threat as a single point-based target relative to the side threat region (e.g., the left threat region 320 or the right threat region 330 of FIG. 3). In such examples, transposing the target (e.g., a vehicle to the side of the host vehicle 200) into a single point-based target may minimize noise as reported by multiple sensors and cameras of the detection module 106, such as dropping/jumping returns or splitting a long semi into multiple targets, to avoid trajectory jumps.

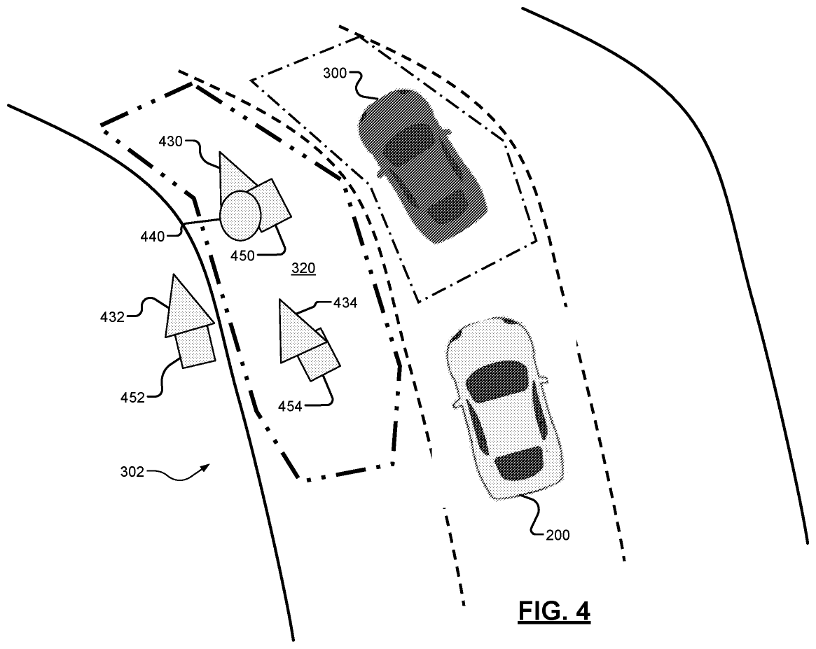

For example, FIG. 4 depicts a diagram including the host vehicle 200 and the front threat vehicle 300 of FIG. 3 traveling along the road 302. In this example, the control module 102 constructed the left threat region 320 of FIG. 3. As shown in FIG. 4, the control module 102 identified various threats generally lateral to the host vehicle 200, such as threats 430, 432, 434, 440, 450, 452, 454. In such examples, the threats 430, 432, 434 (triangular shaped) may be considered fused targets (e.g., multiple targets blended together), the threat 440 (oval shaped) may be a camera detected target, and the threats 450, 452, 454 (square shaped) may be radar detected targets. In various embodiments, a level of confidence (e.g., low, medium, high, etc.) may be associated with each identified threat if desired. While not shown in FIG. 4, it should be appreciated that a similar threat region (e.g., the right threat region 330 of FIG. 3) may be constructed to the right of the host vehicle 200 with threats identified therein if applicable.

Then, the control module 102 of FIG. 1 may determine whether any of the identified side threats are present in the constructed threat region of interest. In various embodiments, the control module 102 may make this determination based on a projected vector. For instance, the control module 102 may generate a vector that projects laterally to each identified threat.

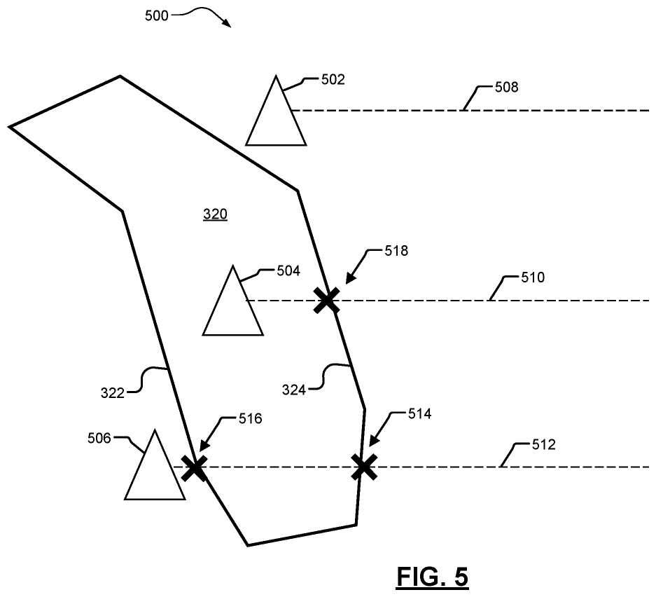

For example, FIG. 5 depicts a diagram including the left threat region 320 of FIG. 3 and various identified threats 502, 504, 506. As shown, the left threat region 320 includes the boundary sides 322, 324. In the example of FIG. 5, a test point may be created for each identified threat 502, 504, 506 that is laterally away (e.g., significantly away) from the host vehicle 200 of FIG. 3 and the threat region 320. In some examples, each test point may be between the host vehicle 200 and the nearest boundary side of the threat region (e.g., the boundary side 324). Then, the control module 102 causes a vector 508, 510, 512 to be projected from the test point to its corresponding identified threat 502, 504, 506, respectively.

The control module 102 can determine whether the identified threats 502, 504, 506 are located in the left threat region 320 based on the vectors 508, 510, 512. For example, the control module 102 can count the number of intersections of the vector (e.g., a test line) with the boundary sides 322, 324 of the left threat region 320. If the number of intersections is an even number (e.g., zero intersections or two intersections), the control module 102 can deduce that the associated identified threat is not within the threat region 320. If, however, the number of intersections is an odd number (e.g., one), the control module 102 can deduce that the associated identified threat is within the threat region 320. In the example of FIG. 5, the vector 508 does not intersect (e.g., zero intersections) the threat region 320 before hitting the threat 502, and therefore the threat 502 is not present in the region 320 of interest as shown. Likewise, the vector 512 intersects the threat region 320 at both boundary sides 322, 324 (e.g., two intersections 514, 516) before hitting the threat 506, and therefore the threat 506 is not present in the region 320. However, the vector 510 intersects the threat region 320 at one boundary side 324 (e.g., one intersection 518) before hitting the threat 504, and therefore the threat 504 is present in the region 320 of interest.

In various embodiments, the control module 102 of FIG. 1 may track targets around the host vehicle 200 even when a noisy perception event occurs. For example, the control module 102 may periodically monitor tracks of targets (e.g., the fused targets/threats 430, 432, 434 of FIG. 4). If a noisy perception event occurs (e.g., a target drops, jumps, returns, etc.), the control module 102 may implement an object perpetuation algorithm to keep track of noisy targets. In such examples, the control module 102 may perpetuate a noisy target based on last known kinematic information. For instance, the control module 102 determines kinematic information associated with a side target/threat (e.g., based on the data obtained from the detection module 106), and tracks it based on the kinematic information. Then, if a noisy perception event occurs such that current kinematic information becomes unavailable, the control module 102 may continue to track the target based on one or more previous values of the kinematic information. In such examples, the control module 102 may continue to use the perpetuated kinematic information to track the target until the noisy perception event ends or a confidence level in the perpetuated information falls below a threshold.

For example, equations (3)-(5) below provide relationships for perpetuating kinematic information for a target. In equations (3) and (4), positions (Iₓₚ, I_{yp}) of the target in the x and y directions (e.g., planes) may be calculated based on the last known positions (Iₓ, I_{y}) in the x and y directions, the derivative of the last known velocity components (Vₓ, V_{y}) in the x and y directions (e.g., the acceleration), and the last known heading angle (h). Additionally, in equation (5), a heading (h) may be calculated as a function of the last known heading angle rate or yaw (γ) and a bank angle (φ).

$${l}_{xp} = ( {l}_{x} + {v}_{x} dt ) cos ( hdt ) + ( {l}_{y} + {v}_{y} dt ) sin ( hdt ) \qquad Equation ( 3 )$$

$${l}_{yp} = - ( {l}_{x} + {v}_{x} dt ) sin ( hdt ) + ( {l}_{y} + {v}_{y} dt ) cos ( hdt ) \qquad Equation ( 4 )$$

$$h = f ( γ , φ ) \qquad Equation ( 5 )$$

With continued reference to FIG. 1, the control module 102 generates and transmits one or more signals to the AES control module 104 based on whether any identified threat is located within a side threat region of interest. For example, in response to determining that an identified threat is present in the threat region (e.g., the left threat region 320 of FIGS. 4-5), the control module 102 may generate and transmit a control signal to the AES control module 104, thereby preventing the AES control module 104 from initiating control of the host vehicle 200 according to a particular AES maneuver along the target path. Alternatively, the control module 102 may generate and transmit a control signal to the AES control module 104, thereby allowing the AES control module 104 to initiate control of the host vehicle 200 according to a particular AES maneuver along the target path in response to determining that an identified threat is not present in the threat region. Still in other embodiments, the control module 102 may not generate and transmit a control signal to the AES control module 104 if an identified threat is not present in the threat region. In such examples, the AES control module 104 may proceed with the AES maneuver.

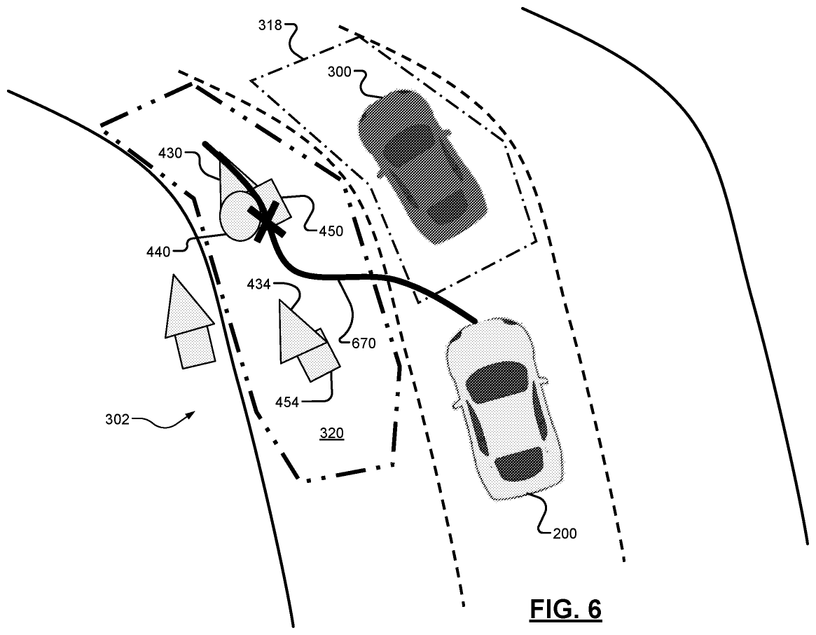

For example, FIG. 6 depicts a diagram including the host vehicle 200 and the front threat vehicle 300 of FIG. 4 traveling along the road 302. In this example, the control module 102 of FIG. 1 detects the threat vehicle 300, constructs the threat region 318 of FIG. 3 around the threat vehicle 300, determines (e.g., based on information from the AES control module 104, the detection module 106, etc.) a target path 670 of a left AES maneuver for the host vehicle 200 to avoid the threat vehicle 300, constructs the left threat region 320 of FIG. 4 (excluding the threat region 318), and then identifies the threats 430, 434, 440, 450, 454 of FIG. 4 as being within the left threat region 320, as explained herein. Once any of the threats 430, 434, 440, 450, 454 are identified as being with the left threat region 320, the control module 102 prevents the AES control module 104 from initiating control of the host vehicle 200 according to the target path 670.

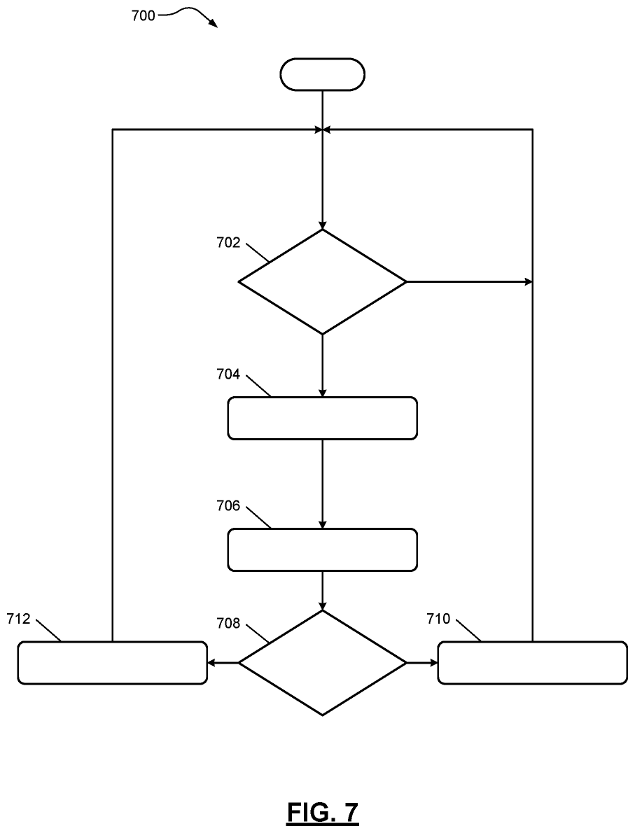

FIGS. 7-11 illustrate example control processes 700, 800, 900, 1000, 1100 employable by the vehicle system 100 of FIG. 1 for evasive steering control in a vehicle (e.g., the vehicle 200 of FIG. 2). Although the example control processes 700, 800, 900, 1000, 1100 are described in relation to the vehicle system 100 of FIG. 1 including the control module 102, any one of the control processes 700, 800, 900, 1000, 1100 may be employable by another suitable system.

In FIG. 7, the control process 700 begins at 702, where the control module 102 detects whether a front threat (e.g., the vehicle 300) is present in front of a host vehicle (e.g., the vehicle 200 of FIG. 2). This determination may be made based on, for example, vehicle data and/or non-driver data obtained from the steering sensor 108, the braking sensor 110, and the sensors 112 and cameras 114 of the detection module 106, as explained above. If no at 702, control returns to 702. If, however, a front threat is detected at 702, control proceeds to 704, where the control module 102 (or the AES control module 104) determines a vehicle target path for an AES maneuver for the host vehicle. Control then proceeds to 706.

At 706, the control module 102 generates a threat region of interest according to the target path. For example, if the target path is to the left, the control module 102 generates a threat region of interest generally to the left of the host vehicle. In such examples, the control module 102 may construct the threat region of interest as an irregular polygonal shape defined by a boundary corresponding to a geometry of the road, as explained above. Control then proceeds to 708.

At 708, the control module 102 determines whether any threat is detected in the generated threat region of interest. For example, the control module 102 may determine various targets lateral to the host vehicle, and then identify whether any of the targets are within the threat region of interest. In such examples, the identified targets within the threat region may be labeled as threats. If no at 708, control proceeds to 710 where the control module 102 allows the AES maneuver to be initiated (e.g., by the AES control module 104) as explained herein. Control then may return to 702 as shown. Otherwise, if yes at 708, control proceeds to 712 where the control module 102 prevents the AES maneuver from being initiated as explained herein. Control then may return to 702.

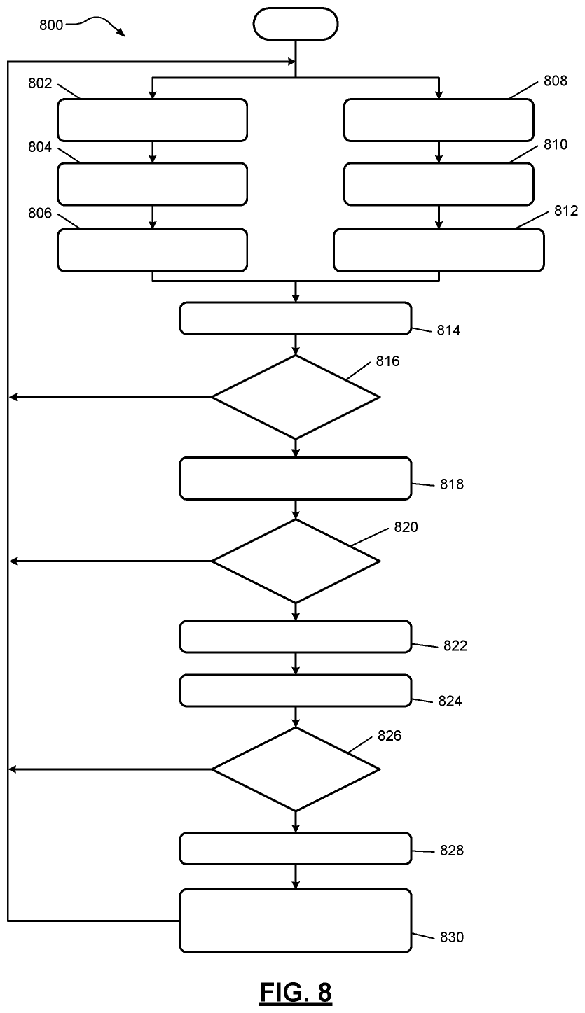

In FIG. 8, the control process 800 begins at 802, 808. At 802, the control module 102 acquires or otherwise detects a target in front of in a host vehicle (e.g., the vehicle 200 of FIG. 2) based on, for example, data obtained from the detection module 106. Control then proceeds to 804, where the control module 102 calculates one or more attributes associated with the target, such as a velocity, an acceleration, a position (e.g., in the x and y directions), a heating, etc. of the target. Such attributes may be calculated based on data obtained from the detection module 106. Control then proceeds to 806, where the control module 102 calculates assesses the detected front target and categorizes a threat level based on one of more of the calculated attributes based on, for example, host vehicle dynamics and the target attributes, as explained herein. Control then proceeds to 814.

At 808, the control module 102 monitors one or more driver inputs associated with the host vehicle. For example, the control module 102 may receive driver inputs from the steering sensor 108 and/or the braking sensor 110 of FIG. 1. Then, control proceeds to 810, where the control module 102 accesses the driver's intention based on the monitored inputs. For example, the control module 102 may determine an intent (e.g., steer to the left, etc.) based on the rotationally angle of the steering wheel, an applied torque on the steering wheel, a torque rate, application of the vehicle brakes, etc. Control then proceeds to 812, where the control module 102 categorizes a driver intention confidence level and direction, as explained herein. Control then proceeds to 814.

At 814, the control module 102 calculates a combined score associated with the front threat level and the driver confidence level. The combined score may be calculated according to equation (2) above. Control then proceeds to 816.

At 816, the control module 102 determines whether the calculated score is greater than a defined threshold. For example, the combined score may range between 0 and 1, and the defined threshold may be 0.5, 0.6, 0.7, etc. If no at 816, control returns to 802, 808. If, however, the combined score is greater than the defined threshold at 816, control proceeds to 818.

At 818, the control module 102 determines if any side threats (e.g., other vehicles) are on the side of the host vehicle that corresponds to the driver's intent. For example, if the driver's intent is to steer to the left, the control module 102 may determine whether any objects are present to the left side of the host vehicle. In various embodiments, the control module 102 makes this determination based on obtained data from the detection module 106, as explained herein. Control proceeds to 820, where the control module 102 determines whether the side (e.g., the side) is clear of threats. If no (e.g., threats are present), control returns to 802, 808. Otherwise, if the side is clear of threats at 820, control proceeds to 822, 824.

The control module 102 calculates or otherwise determines an AES target path for the host vehicle to avoid the front threat at 822, and then determines if any threats (e.g., other vehicles) are located along the target path at 824, as explained herein. Control proceeds to 826, where the control module 102 determines whether the target path is clear of threats, as explained above. If no (e.g., threats are present in the AES path), control returns to 802, 808. Otherwise, if the target path is clear of threats at 826, control proceeds to 828.

At 828, the control module 102 allows initiation of an AES maneuver along the target path (e.g., via the AES control module 104 of FIG. 1), as explained herein. Control then proceeds to 830, where the AES control module 104 controls the host vehicle along the AES target path until the front threat is avoided and a desired position and heading of the host vehicle are achieved. Control then returns to 802, 808.

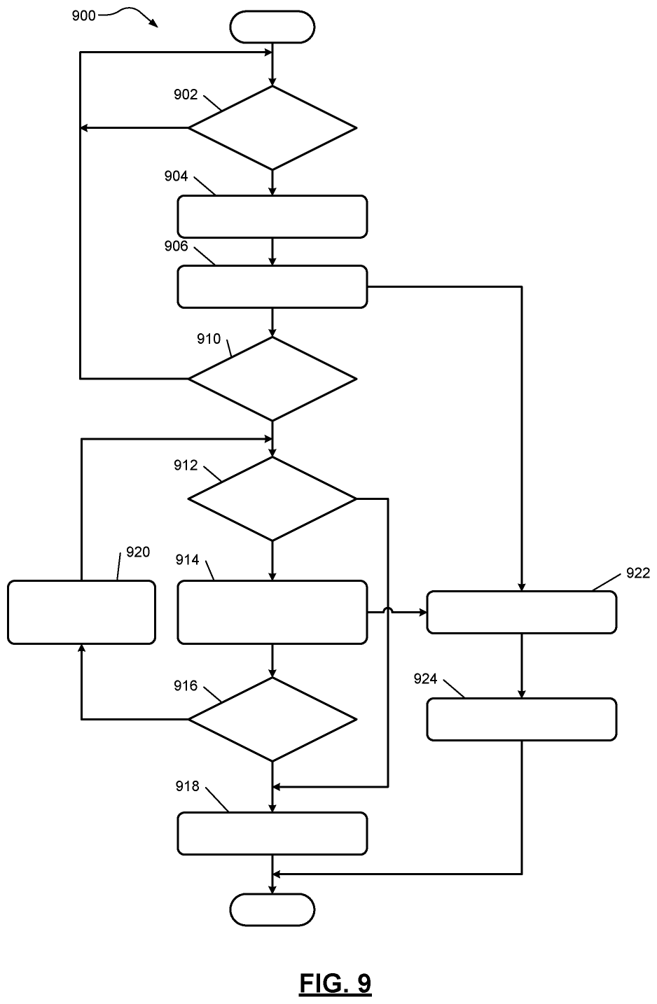

In FIG. 9, the control process 900 begins at 902, where the control module 102 determines whether an AES functioning system is enabled on a host vehicle (e.g., the vehicle 200 of FIG. 2). If no, control returns to 902 or may end. If yes at 902, control proceeds to 904, 906

At 904, the control module 102 creates a target region and a relative position of the target region with respect to the host vehicle. For example, the control module 102 may create the target region from a point-based target using target size estimation (e.g., based on obtained data from the detection module 106). Then, at 906, the control module 102 creates assigns a specific track to each target (e.g., each fused target 430, 432, 434 of FIG. 4) in the target region. Control then proceeds to 910, 922.

At 910, the control module 102 detects whether a noisy perception event has occurred. In such examples, the noisy perception event may include, for example, a target that is dropped, jumped, returned, etc. In other examples, the noisy perception event may include a detected target track identifier that was dropped. If no at 910, control returns to 902 as shown or 910 if desired. If yes at 910, control proceeds to 912.

At 912, the control module 102 determines whether each target has returned to its fused target track. For example, the control module 102 may make this determination if both relationships shown in equations (6) and (7) below are true. In such examples, Iₓ, I_{y} represent the last known positions in the x and y directions, Iₓₚ, I_{yp} represent the calculated positions of the target as determined in equations (2) and (4) above, and dₓ, d_{y} represent thresholds. If each target has returned to its fused target track (e.g., both equations (6) and (7) are true for each target), control proceeds to 918. If, however, each target has not returned to its fused target track (e.g., either one of equations (6) and (7) are not true for a target), control proceeds to 914.

$$\vert {l}_{x} - {l}_{xp} \vert < {d}_{x} \qquad Equation ( 6 )$$

$$\vert {l}_{y} - {l}_{yp} \vert < {d}_{y} \qquad Equation ( 7 )$$

At 914, the control module 102 perpetuates the targets that have not returned to their fused target tracks based on last known kinematic information, as explained above. For example, the control module 102 may implement equations (3)-(5) above to perpetuate such targets. Control proceeds to 916, 922.

At 916, the control module 102 determines whether perpetuated target confidence levels for the targets is less than a threshold or if the targets have returned to their fused target tracks. If no, control proceeds to 920 where the control module continues to monitor the perpetuated targets. Control then returns to 912. If yes at 916, control proceeds to 918 where the control module stops monitoring the perpetuated targets. Control may then end if desired.

At 922, the control module 102 appends the fused target track(s) with the associated perpetuated target track(s) to maintain continuum in target reporting. Control then proceeds to 924 where the control module 102 creates a threat region of interest as explained herein.

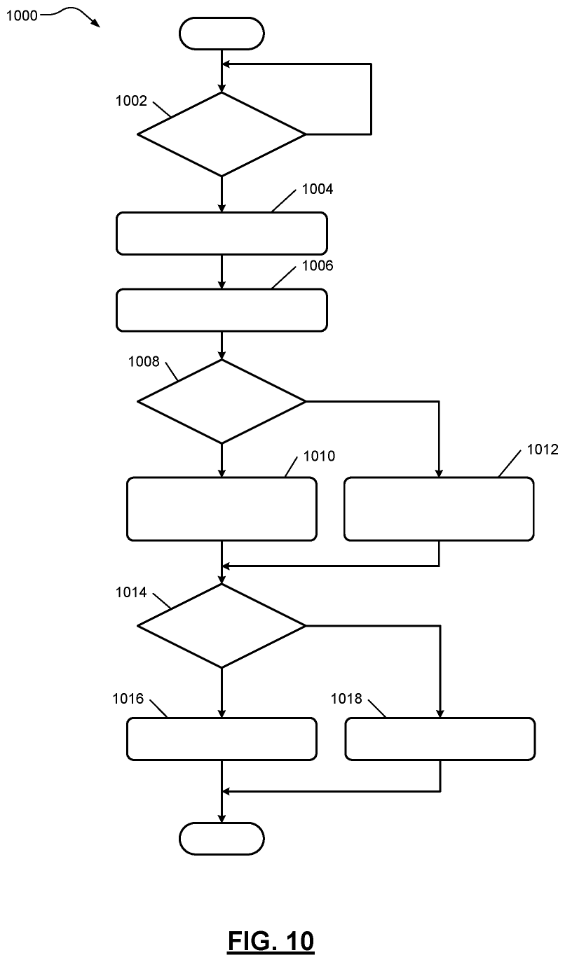

In FIG. 10, the control process 1000 begins at 1002, where the control module 102 determines whether an AES functioning system is enabled on a host vehicle (e.g., the vehicle 200 of FIG. 2) and a front threat is detected as explained herein. If no, control returns to 1002 or may end. If yes at 1002, control proceeds to 1004, where the control module 102 monitors a target path of the host vehicle and estimates an alternate path (e.g., an AES path) to avoid front threat. Control then proceeds to 1006.

At 1006, the control module 102 begins creating a front threat region of interest. Specifically, at 1006, the control module 102 creates longitudinal vertices of the front threat region of interest based on, for example, the front threat's kinematics (e.g., as a function of the position, velocity, etc. of the front threat). The control module 102 may then connect (e.g., enclose) the longitudinal vertices with a boundary to create the front threat region of interest. Control then proceeds to 1008.

At 1008, the control module 102 determines if the AES path is to the left. If yes, control proceeds to 1010 where the control module assigns lateral vertices to the left of the host vehicle and then connects (e.g., encloses) the lateral vertices to form a boundary of a left threat region of interest (which excludes the front threat region), as explained herein. Control then proceeds to 1014. If no at 1008 (e.g., the AES path is to the right), control proceeds to 1012 where the control module assigns lateral vertices to the right of the host vehicle and then connects (e.g., encloses) the lateral vertices to form a boundary of a right threat region of interest (which excludes the front threat region), as explained herein. Control then proceeds to 1014.

At 1014, the control module 102 determines whether the AES path is clear. For example, the control module 102 can determine if any identified target/threat is present in the left threat region of interest or the right threat region of interest (depending on which threat region was constructed at 1010, 1012). If yes at 1014, control proceeds to 1016 where the control module 102 allows the AES maneuver to be initiated (e.g., by the AES control module 104) as explained herein. Control may then end as shown or return to 1002. Otherwise, if no at 1014, control proceeds to 1018 where the control module 102 prevents the AES maneuver from being initiated as explained herein. Control may then end as shown or return to 1002.

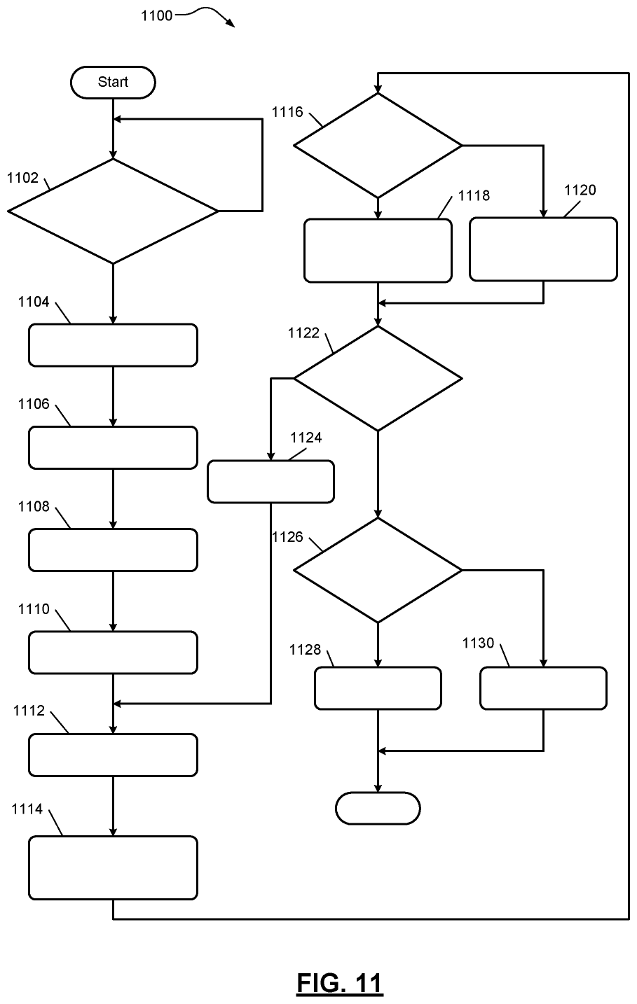

In FIG. 11, the control process 1100 begins at 1102, where the control module 102 determines whether an AES functioning system is enabled on a host vehicle (e.g., the vehicle 200 of FIG. 2), a front threat is detected, and a side for an AES maneuver is determined, as explained herein. If no, control returns to 1102 or may end. If yes at 1102, control proceeds to 1104, 1106, 1108, 1110.

At 1104, the control module 102 generates a threat region of interest on the side for the AES maneuver, as explained above. Then, at 1106, the control module 102 generates may apply one or more tapers at a rear of the threat region of interest to suppress false detections, as explained above. At 1108, the control module 102 identifies targets to the side of the host vehicle in which the AES maneuver is planned as explained herein. The control module 102 then selects one of the identified targets at 1110. Control then proceeds to 1112.

At 1112, the control module 102 projects a vector from (or to) the selected target to (or from) a lateral test point, as explained above. Control then proceeds to 1114, where the control module 102 determines how many times the vector intersects the boundary of the threat region of interest. Control then proceeds to 1116.

At 1116, the control module 102 determines whether the number of vector intersections is an odd number (e.g., 1). If yes, the target is deemed to be a threat within the threat region of interest at 1118. Control then proceeds to 1122. If, however, the number of vector intersections is not an odd number (e.g., is an even number such as 0 or 2), the target is deemed to be outside the threat region of interest at 1120. Control then proceeds to 1122.

At 1122, the control module 102 determines whether any identified targets at 1108 remain. If yes, the control module 102 selects the next identified target at 1124. Control then returns to 1112. If no at 1122, control proceeds to 1126 where the control module 102 determines if any of the identified targets are deemed to be a threat within the threat region of interest. If no at 1126, control proceeds to 1128 where the control module 102 allows the AES maneuver to be initiated (e.g., by the AES control module 104) as explained herein. Control then may end. Otherwise, if yes at 1126, control proceeds to 1130 where the control module 102 prevents the AES maneuver from being initiated as explained herein. Control may then end.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A vehicle system for evasive steering control in a vehicle, the vehicle system comprising:
an avoid evasive steering (AES) module configured to automatically control the vehicle; and
a control module in communication with the AES module, the control module configured to:
detect whether a first threat is present in front of the vehicle;
in response to detecting the first threat in front of the vehicle, determine a path of the vehicle for an AES maneuver to avoid the first threat in front of the vehicle;
generate a threat region of interest lateral to the vehicle along the path of the vehicle for the AES maneuver;
determine whether a second threat is present in the threat region of interest; and
in response to determining that the second threat is present in the threat region of interest, prevent the AES module from initiating control of the vehicle according to the AES maneuver.

2. The vehicle system of claim 1, wherein the control module is configured to transmit a control signal to the AES module to initiate control of the vehicle according to the AES maneuver in response to determining that the second threat is not present in the threat region of interest.

3. The vehicle system of claim 1, wherein the threat region of interest is an irregular polygonal shape defined by a boundary corresponding to a geometry of a road in which the vehicle is moving on.

4. The vehicle system of claim 3, wherein the control module is configured to construct vertices of the boundary based on one or more of a width of a road lane, a trajectory of the vehicle, an area associated with the first threat in front of the vehicle, and a width associated with the vehicle.

5. The vehicle system of claim 3, wherein the control module is configured to:
identify, based on data received from one or more sensors, the second threat lateral to the vehicle as the vehicle is moving; and
project a vector to determine whether the second threat is present in the threat region of interest.

6. The vehicle system of claim 1, wherein the control module is configured to determine kinematic information associated with the second threat and track the second threat based on the kinematic information.

7. The vehicle system of claim 6, wherein the control module is configured to track the second threat based on one or more previous values of the kinematic information.

8. The vehicle system of claim 1, wherein the control module is configured to:
receive vehicle data associated with one or more parameters of the vehicle while the vehicle is moving, the vehicle data indicative of an intent of a driver controlling the vehicle;
receive non-driver data indicative of environment parameters in front of the vehicle while the vehicle is moving; and
detect whether the first threat is present in front of the vehicle based on the vehicle data and the non-driver data.

9. The vehicle system of claim 8, wherein the one or more parameters of the vehicle includes at least one of a steering angle received from a steering angle sensor in the vehicle and a brake signal received from a braking sensor in the vehicle.

10. The vehicle system of claim 8, wherein the non-driver data includes data associated with another vehicle in front of the vehicle.

11. The vehicle system of claim 8, wherein the control module is configured to:
determine a confidence value of the driver based on the vehicle data;
determine a threat value based on the non-driver data;
calculate a score based on the confidence value and the threat value; and
detect whether the first threat is present in front of the vehicle based on the score and a threshold.

12. A vehicle including the vehicle system of claim 1 configured to control evasive steering of the vehicle.

13. A method for controlling evasive steering in a vehicle, the method comprising:
detecting whether a first threat is present in front of the vehicle;
in response to detecting the first threat in front of the vehicle, determining a path of the vehicle for an avoid evasive steering (AES) maneuver to avoid the first threat in front of the vehicle;
generating a threat region of interest lateral to the vehicle along the path of the vehicle for the AES maneuver;
determining whether a second threat is present in the threat region of interest; and
in response to determining that the second threat is present in the threat region of interest, preventing an AES module from initiating control of the vehicle according to the AES maneuver.

14. The method of claim 13, wherein the threat region of interest is an irregular polygonal shape defined by a boundary corresponding to a geometry of a road in which the vehicle is moving on.

15. The method of claim 14, further comprising constructing vertices of the boundary based on one or more of a width of a road lane, a trajectory of the vehicle, an area associated with the first threat in front of the vehicle, and a width associated with the vehicle.

16. The method of claim 13, wherein determining whether the second threat is present in the threat region of interest includes:
identifying, based on data received from one or more sensors, the second threat lateral to the vehicle as the vehicle is moving; and
projecting a vector to determine whether the second threat is present in the threat region of interest.

17. The method of claim 13, further comprising determining kinematic information associated with the second threat and tracking the second threat based on the kinematic information.

18. The method of claim 17, wherein tracking the second threat includes tracking the second threat based on one or more previous values of the kinematic information.

19. The method of claim 13, wherein:
the method further comprises receiving vehicle data associated with one or more parameters of the vehicle while the vehicle is moving, the vehicle data indicative of an intent of a driver controlling the vehicle, and receiving non-driver data indicative of environment parameters in front of the vehicle while the vehicle is moving; and
detecting whether the first threat is present in front of the vehicle includes detecting whether the first threat is present in front of the vehicle based on the vehicle data and the non-driver data.

20. The method of claim 19, wherein:
the method further comprises determining a confidence value of the driver based on the vehicle data, determining a threat value based on the non-driver data, and calculating a score based on the confidence value and the threat value; and
detecting whether the first threat is present in front of the vehicle includes detecting whether the first threat is present in front of the vehicle based on the score and a threshold.
